(19) United States
(12) Patent Application Publication
(10) Pub. No.: US 2022/0244078 A1
(43) Pub. Date: Aug. 4, 2022

(54) CAPACITIVE DIFFERENTIAL ROTARY ENCODER

(71) Applicant: Cypress Semiconductor Corporation, San Jose, CA (US)

(72) Inventors: Brendan McAndrews, Seattle, WA (US); Vibheesh Bharathan, San Jose, CA (US); Igor Kravets, Lviv (UA); Mykhaylo Krekhovetskyy, Lviv (UA); David Durlin, Castle Rock, WA (US)

(73) Assignee: Cypress Semiconductor Corporation, San Jose, CA (US)

(21) Appl. No.: 17/496,639

(22) Filed: Oct. 7, 2021

Related U.S. Application Data
(60) Provisional application No. 63/144,775, filed on Feb. 2, 2021.

(51) Int. Cl. G01D 5/241; G06F 3/0362

(52) U.S. Cl. CPC G01D 5/2415; G06F 3/0362

(57) ABSTRACT

A rotary encoder for capturing angular position of a target rotating over capacitive sensors. The rotary encoder includes a source plate. The rotary encoder includes a pair of capacitive sensors coupled to the source plate, and a target plate separated from the source plate by a gap. The target plate includes a spoke and a flange. The spoke is capacitively coupled to the pair of capacitive sensors and the flange is capacitively coupled to a ground pad. Each capacitive sensor of the pair of capacitive sensors is configured to detect a change in a capacitive value corresponding to an angular position of the spoke to the capacitive sensor. The target plate is mechanically coupled to a joystick. A movement of the joystick causes a rotation of the target plate about an axis to change the angular position of the spoke to the pair of capacitive sensors.

### CROSS-REFERENCE TO RELATED APPLICATIONS

This application claims the benefit of U.S. Provisional Patent Application No. 63/144,775, filed Feb. 2, 2021, which is incorporated by reference herein in its entirety.

### TECHNICAL FIELD

The present disclosure relates generally to the field of gaming controllers, and more particularly, to a capacitive differential rotary encoder for capturing angular position of a target rotating over one or more capacitive sensors.

### BACKGROUND

A rotary encoder is a type of position sensor which is used for determining the angular position of a rotating shaft. It generates an electrical signal, either analog or digital, according to the rotational movement. Unlike a potentiometer, a rotary encoder is capable of continuous rotation. A joystick used to play a video game may use a rotary encoder to track the movement of the joystick.

### BRIEF DESCRIPTION OF THE DRAWINGS

The present disclosure is illustrated by way of example, and not by way of limitation, in the figures of the accompanying drawings in which like reference numerals refer to similar elements and in which:

FIG. 1 illustrates a block diagram of an example integrated circuit for detecting angular position of a capacitive differential rotary encoder, according to some embodiments;

FIG. 2 illustrates a block diagram of an example capacitive differential rotary encoder for capturing angular position of a one-spoke target plate with flange that is rotating over a pair of capacitive sensors, according to some embodiments;

FIG. 2A illustrates a block diagram of a side view of an example capacitive differential rotary encoder, according to some embodiments;

FIG. 2B is a graph illustrating capacitance of a differential pair of capacitive sensors versus an angular position a spoke of a target plate rotating over the differential pair of capacitive sensors, according to some embodiments;

FIG. 3 illustrates a block diagram of an example capacitive differential rotary encoder for capturing angular position of a two-spoke target plate that is rotating over two pairs of capacitive sensors, according to some embodiments;

FIG. 4 illustrates a block diagram of an example capacitive differential rotary encoder for capturing angular position of a three-spoke target plate that is rotating over three pairs of capacitive sensors, according to some embodiments;

FIG. 5 illustrates a block diagram of an example capacitive differential rotary encoder for capturing angular position of a horseshoe target plate that is rotating over two curved-rectangular capacitive sensors, according to some embodiments; and

FIG. 6 is a flow diagram of a method for capturing angular position of a target rotating over one or more capacitive sensors, according to some embodiments.

### DETAILED DESCRIPTION

The following description sets forth numerous specific details such as examples of specific systems, components, methods, and so forth, in order to provide a good understanding of various embodiments of the techniques described herein for an efficient secure phase-based ranging using loopback calibration. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

There are various types of joystick technology. A potentiometer joystick uses a potentiometer, which is a variable resistor that uses a physical wiper arm that slides across the internal electrical element to change the resistance. Potentiometers are traditionally used as analog voltage dividers that provide voltage output signals and are manufactured using one of several electrical element types: carbon, cermet, wire wound or conductive plastic. The potentiometer joystick, however, is susceptible to the eventual wear and tear caused by the sliding friction of the wiper arm as the potentiometer shaft is rotated. It is also susceptible to electromagnetic interference or radio frequency interference.

The Hall effect joystick has an advantage over the potentiometer joystick in that there is no physical contacting wear issue with the sensor itself. But the bails mechanism or gimbal mechanism for each magnet does move and will wear over time thus causing mechanical hysteresis. Also, the Hall effect joystick does have a limitation in the very nature of the ferromagnetic material that is used, as its magnetic field will change over time and is directly affected by temperatures. These variances in the magnetic field will cause the Hall effect joystick to “drift”. That is, the output voltage of the Hall effect joystick will unwantedly vary and cause undesired effects. Therefore, the long term reliability of the Hall effect joystick is limited.

The inductive joystick uses a set of coiled copper wires laid out in a circular format to which a current is applied inducing a magnet field. A metal shaft is then placed within the toroidal coil, when moved within this magnet field it cuts through or interferes with the magnetic lines of force thus inducing a change in the flow of current in the coil. The change in current flow is correlated to a change in the proportional voltage output provided by the inductive joystick. The inductive joystick, however, is susceptibility to interference by extraneous electromagnetic of radio frequency signals.

Aspects of the disclosure address the above-noted and other deficiencies by disclosing a capacitive differential (CD) rotary encoder for capturing angular position of a target rotating over one or more capacitive sensors. As described in the below passages, the CD rotary encoder (sometimes referred to as, “rotary encoder”) includes a source plate that includes a ground pad, a pair (e.g., differential) of capacitive sensors coupled to the source plate, and a target plate that is separated from the source plate by a gap. The target plate includes a spoke and a flange, where the spoke is capacitively coupled to the pair of capacitive sensors and the flange is capacitively coupled to the ground pad. Each capacitive sensor of the pair of capacitive sensors detects a change in a capacitive value corresponding to an angular position of the spoke to the capacitive sensor, and generates signals that include information indicative of the change in capacitive value of the capacitive sensors. The target plate is mechanically coupled to a joystick such that a movement of the joystick causes a rotation of the target plate about an axis to change the angular position of the spoke to the pair of capacitive sensors. The CD rotary encoder includes input/output (IO) pins for providing the signals to an integrated circuit, such that the integrated circuit may determine an angular position (e.g., relative or absolute) of the CD rotary encoder using the signals.

The CD rotary encoder may be used in a wide range of applications that require monitoring or control, or both, of mechanical systems, including industrial controls, robotics, medical devices, photographic lenses, computer input devices such as optomechanical mice and trackballs, controlled stress rheometers, rotating radar platforms, and/or handheld controllers (e.g., video game controllers, simulator controllers), etc.

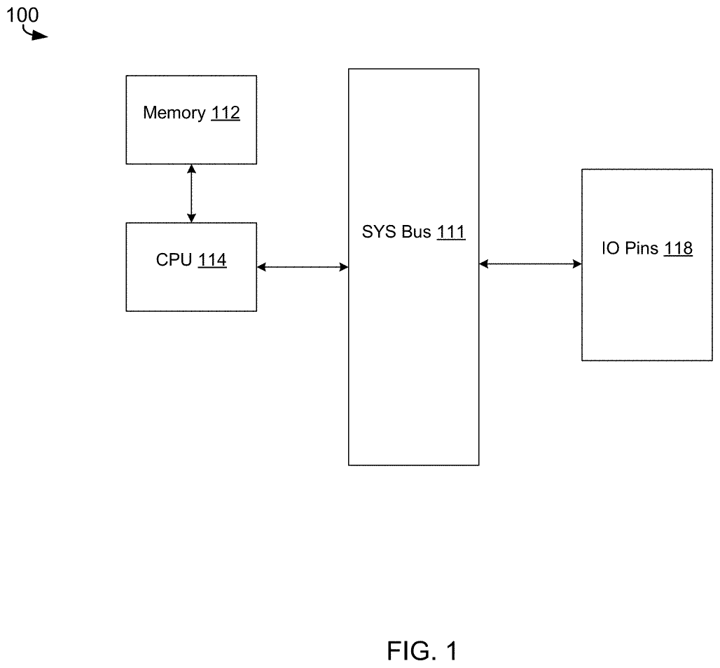

FIG. 1 illustrates a block diagram of an example integrated circuit for detecting angular position of a capacitive differential rotary encoder, according to some embodiments. In this embodiment, the integrated circuit 100 (e.g., a microcontroller) includes a system bus 111, and coupled to the system bus 111 is a memory 112 for storing instructions (e.g., firmware) and temporary data during firmware execution, a central processing unit (CPU) 114 for processing information (e.g., performing calculations, making determinations, etc.) and instructions, and input/output (I/O) pins 118 for providing an interface with a capacitive differential encoder.

As discussed herein, the IO pins 118 may be coupled to one or more nodes (e.g., pads) of a capacitive differential encoder. In some embodiments, the integrated circuit 100 may be configured to receive information (e.g., signals including and/or indicative of capacitive values) from the capacitive differential encoder via the I0 pins 118 and determine (e.g., calculate, estimate) an angular position of the capacitive differential encoder using the information.

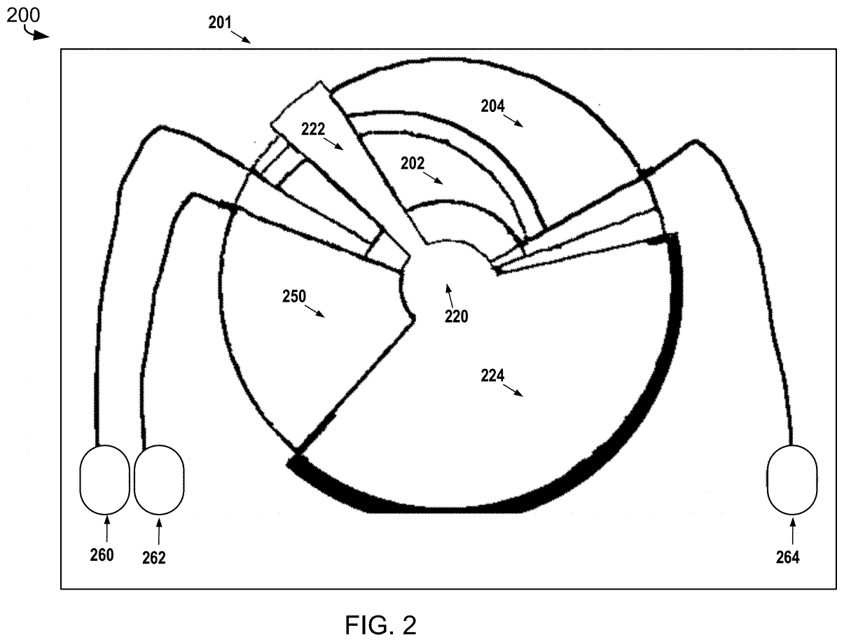

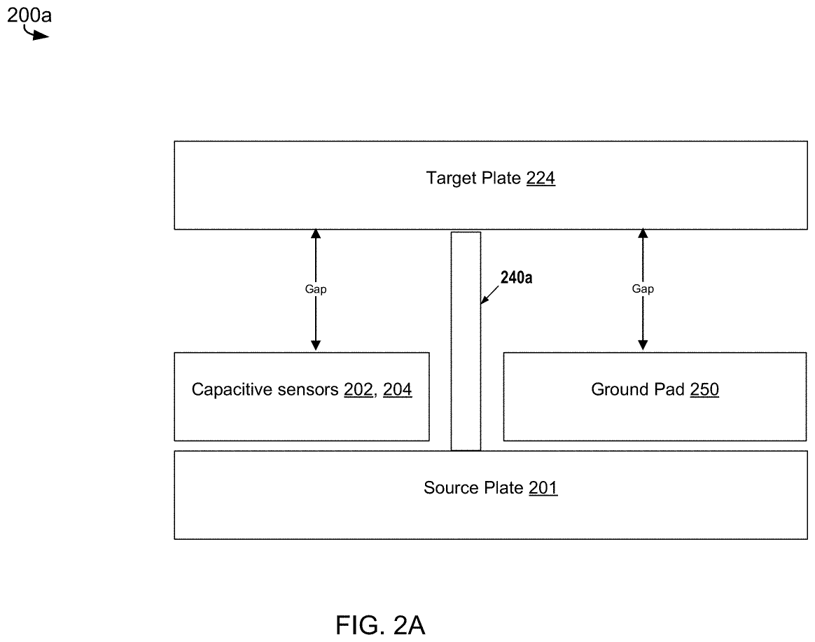

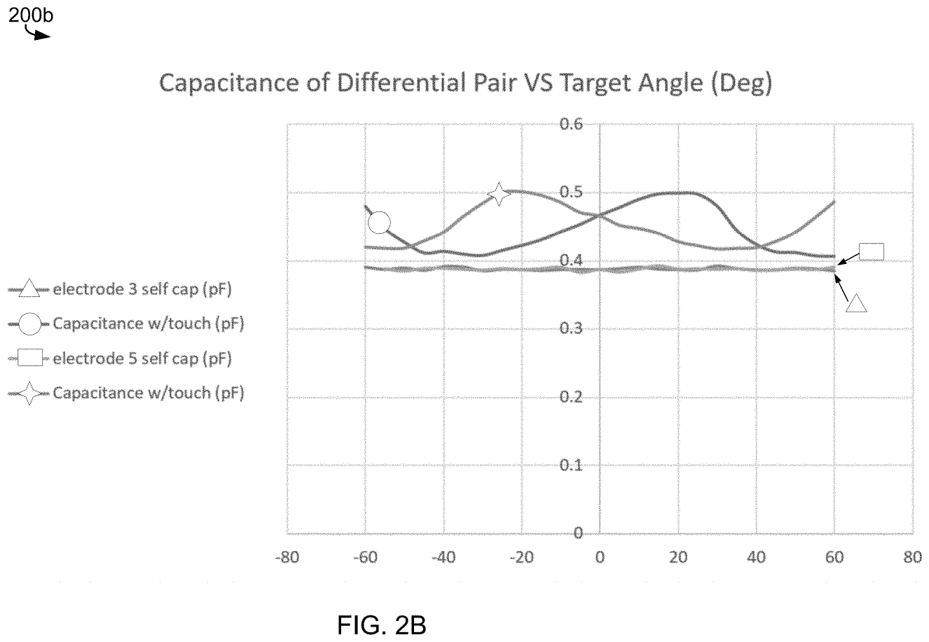

FIG. 2 illustrates a block diagram of an example capacitive differential rotary encoder for capturing angular position of a one-spoke target plate with flange that is rotating over a pair of capacitive sensors, according to some embodiments. In some embodiments, the capacitive differential (CD) rotary encoder 200 includes a pair of capacitive sensors 202, 204. In some embodiments, the CD rotary encoder 200 includes a ground pad 250. In some embodiments, the CD rotary encoder 200 includes a target plate 220 and an axis (not shown in FIG. 2) for the target plate 220 to rotate about the axis. In some embodiments, the target plate 220 includes a spoke 222 and a flange 224.

In some embodiments, the CD rotary encoder 200 may include a source plate 201 (e.g., a substrate, a surface, a layer), where the pair of capacitive sensors 202, 204 and the axis may each be attached (e.g., coupled, adhered, affixed, included, embedded) to the source plate 201. In this regard, the capacitive sensors 202, 204 are stationary (e.g., fixed, static) with respect to the source plate 201. In some embodiments, a source plate 201 may correspond to a side of a three-dimensional (e.g., circular, cube) joystick housing such that the pair of capacitive sensors 202, 204 and the axis may each be attached to the side of the joystick housing. In some embodiments, a first CD rotary encoder 200 may be attached to a first side of the joystick housing to detect the movement of the joystick of the joystick housing in a vertical (e.g., up/down) direction and/or a second CD rotary encoder 200 may be attached to a second side of the joystick housing to detect the movement of the joystick of the joystick housing in a horizontal (e.g., side-to-side) direction.

In some embodiments, the capacitive sensor 202 is electrically coupled to a signal node 260. In some embodiments, the capacitive sensor 204 is electrically coupled to a signal node 262. In some embodiments, the ground pad 250 is electrically coupled to a ground node 264. In some embodiments, the signal nodes 260, 262 and the ground node 264 are electrically coupled to corresponding pads of the integrated circuit 100 in FIG. 1.

As shown in FIG. 2, the CD rotary encoder 200 and the target plate 220 may each be circular. In some embodiments, the CD rotatory encoder 200 and/or the target plate 220 may be any shape, such as a regular polygon, an irregular polygon, a quadrilateral (e.g., rectangle, square), a circle, etc. The pair of capacitive sensors 202, 204 are attached (e.g., coupled, adhered, affixed, included, embedded) to the source plate 201 in an arrangement where an inner edge of the capacitive sensor 202 (sometimes referred to as, “inner capacitive sensor 202”) is closer (e.g., adjacent) to the center of the target plate 220 as compared to an outer edge of the capacitive sensor 202, and an inner edge of the capacitive sensor 204 (sometimes referred to as, “outer capacitive sensor 204”) is closer to the outer edge of the capacitive sensor 202 as compared to an outer edge of the capacitive sensor 204. In some embodiments, the pair of capacitive sensors 202, 204 may be attached to the source plate 201 in any arrangement.

In some embodiments, the target plate 220 may be separated (e.g., distanced) from the source plate 201 by a gap (e.g., space, void). For example, FIG. 2A illustrates a block diagram of a side view of an example capacitive differential rotary encoder, according to some embodiments. The side view 200a shows the capacitive sensors 202, 204 and the ground pad 250 as being attached to the source plate 201. The side view 200a shows that the target plate 224 is attached to the source plate 201 via an axis 240a. The side view 200a shows that there is a gap between the target plate 224 and the capacitive sensors 202, 204 and the ground pad 250 to create capacitive coupling between the target plate 224 and the capacitive sensors 202, 204 and/or the ground pad 250.

Referring back to FIG. 2, in some embodiments, the spoke 222 may be capacitively coupled to the pair of capacitive sensors 202, 204. In some embodiments, the flange 224 may be capacitively coupled to the ground pad 250. In some embodiments, the spoke 222 may be capacitively coupled to the pair of capacitive sensors 202, 204 at the same time that the flange 224 is capacitively coupled to the ground pad 250.

As shown in FIG. 2, the flange 224 has a surface area that is larger than the surface area of the spoke 222, which results in a capacitive coupling between the flange 224 and the ground pad 250 that is greater than the capacitive coupling between the spoke 222 and the pair of capacitive sensors 202, 204. In this instance, this larger coupling between flange 224 and the ground pad 250 may improve the immunity of the CD rotary encoder 200 to human touch (e.g., may cause unwanted changes in capacitance) and/or electromagnetic interference (EMI); thereby improving the ability for the CD rotary encoder 200 to accurately detect the movement of a joystick

In some embodiments, the target plate 220 may be mechanically coupled to a joystick (not shown in FIG. 2), such that a movement of the joystick may cause the target plate 220 (and its spoke 222) to rotate about the axis. In this instance, the rotation of the target plate 220 about the axis causes a change in the angular position (e.g., in degrees, in revolutions) of the spoke 222 with respect to the pair of capacitive sensors, 202, 204. For example, at a first time slot, the spoke may have an angular position of 0 degrees with respect to a first region on the capacitive sensor 202 and an angular position of 0 degrees with respect to a first region on the capacitive sensor 204. At a second time slot, the movement of the joystick may cause the spoke 222 to rotate 10 degrees such that the spoke has an angular position of 10 degrees with respect to the first region on the capacitive sensor 202 and an angular position of 10 degrees with respect to the first region on the capacitive sensor 204.

In some embodiments, a capacitive sensor (e.g., capacitive sensors 202, 204) may be configured to detect (e.g., sense) a change (e.g., variation, deviation) in a capacitive value, where the change corresponds to an angular position of the spoke 222 to the capacitive sensor. For example, as the target plate 220 rotates about the axis, the spoke 222 moves in an arc over the pair of capacitive sensors, 202, 204. The capacitive value of a capacitive sensor increases as the distance between the capacitive sensor and the spoke 222 decreases. Conversely, the capacitive value of the capacitive sensor decreases as the distance between the capacitive sensor and the spoke 222 increases. In some embodiments, a capacitive sensor may be configured to detect (e.g., sense, identify) a change in a capacitive value, where the change corresponds to an absolute angular position of the spoke 222 to the capacitive sensor.

In some embodiments, the capacitive sensor 204 may be configured to generate, responsive to detecting the change in the capacitive value of the capacitive sensor 204, a signal that includes information that is indicative of the change in the capacitive value of the capacitive sensor 204. For example, FIG. 2B is a graph illustrating capacitance of a differential pair of capacitive sensors versus an angular position a spoke of a target plate rotating over the differential pair of capacitive sensors, according to some embodiments. The x-axis of the graph 200b shows an angular position of the spoke 222 of the target plate 220 with respect to a differential pair of capacitive sensors (e.g., capacitive sensors 202, 204). The y-axis of the graph 200b shows the amount of capacitance (as represented by a signal generated by the differential pair of capacitance sensors) that corresponds to the angular position of the spoke 222 of the target plate 220.

The graph 200b shows four series of datapoints. The graph 200b shows the resultant capacitance for a series labeled, “electrode 3 self cap (pF).” The graph 200b shows the resultant capacitance for a series labeled, “capacitance w/touch (pf).” The graph 200b shows the resultant capacitance for a series labeled, “electrode 5 self cal (pF).” The graph 200b shows the resultant capacitance for a series labeled, “Capacitance w/touch (pF).”

Referring back to FIG. 2, in some embodiments, a width of the spoke 222 is directly related to a power level (e.g., amplitude, magnitude) of the signal that is generated by the capacitor sensor 202 and/or a power level of the signal that is generated by the capacitor sensor 204. In some embodiments, a width of the spoke 222 is inversely (e.g., indirectly) related to an angular resolution of the capacitive sensor 202 to the spoke 222. In some embodiments, a width of the spoke 222 is inversely related to an angular resolution of the capacitive sensor 204 to the spoke 222. For example, an increase in the width of the spoke 222 may decrease the angular resolution of the capacitive sensor 204 to the spoke 222. As another example, a decrease in the width of the spoke 222 may increase the angular resolution of the capacitive sensor 204 to the spoke 222. In some embodiments, a width of the spoke 222 may be equal to or less than a width of the capacitive sensor 202 and/or the capacitive sensor 204.

In some embodiments, a power level of the signal that is generated by the capacitive sensor 202 is directly related to a size of a surface area of the capacitive sensor 202 that is overlapped (e.g., hovering over without direct physical contact) by the spoke 222. For example, an increase in the size of the surface area of the capacitive sensor 202 will increase the power level (e.g., amplitude, magnitude) of the signal that is generated by the capacitive sensor 202. As another example, a decrease in the size of the surface area of the capacitive sensor 202 will decrease the power level of the signal that is generated by the capacitive sensor 202. In some embodiments, a power level of the signal that is generated by the capacitive sensor 204 is directly related to a size of a surface area of the capacitive sensor 204 that is overlapped by the spoke 222.

In some embodiments, the capacitive sensor 202 and/or the capacitive sensor 204 is fin-shaped with an inner radius corresponding to a radius of the target plate 220. In some embodiments, the rotation of the target plate 220 about the axis causes the spoke 222 to move in an arc (e.g., curve) over the pair of capacitive sensors 202, 204. In some embodiments, the pair of capacitive sensors have, for example, an arc length of 120+/−5 degrees, which may improve the immunity of the CD rotary encoder 200 to human touch (e.g., may cause unwanted changes in capacitance) and/or electromagnetic interference (EMI); thereby improving the ability for the CD rotary encoder 200 to accurately detect the movement of a joystick.

In some embodiments, the capacitive sensor 202 and the capacitive sensor 204 are attached to the source plate 201 in a mirror orientation that causes the capacitive sensor 202 and the capacitive sensor 204 generate complementary signals responsive to the rotation of the target plate 220 about the axis. For example, the spoke 222 may be positioned over the left-most region of the capacitive sensor 204 and the capacitive sensor 204. In this instance, the capacitive sensor 202 would generate a signal having a maximum power and the capacitive sensor 204 would generate a signal having a minimum power. As another example, the spoke 222 may be positioned over the right-most region of the capacitive sensor 202 and the capacitive sensor 204. In this instance, the capacitive sensor 202 would generate a signal having a minimum power and the capacitive sensor 204 would generate a signal having a maximum power.

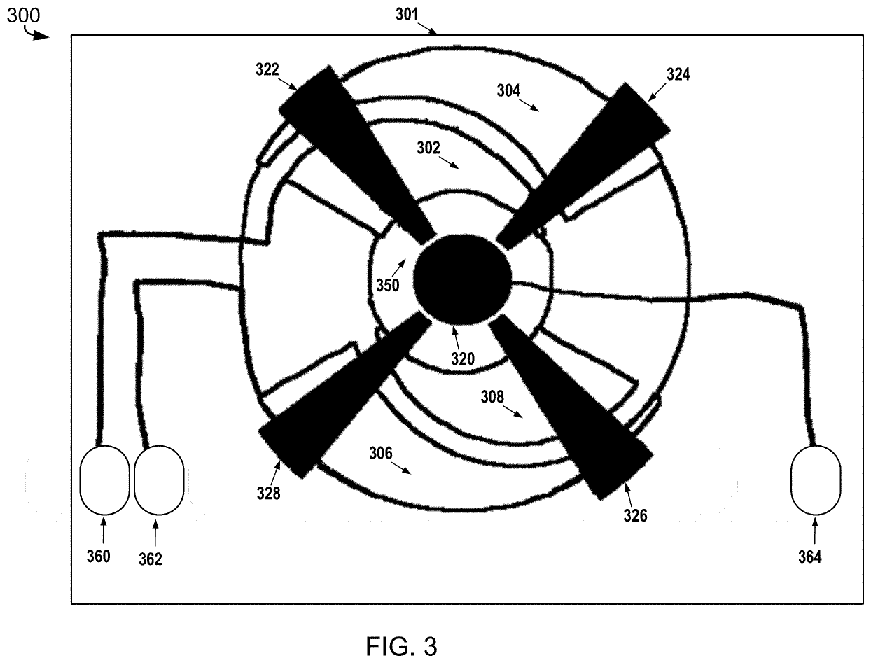

FIG. 3 illustrates a block diagram of an example capacitive differential rotary encoder for capturing angular position of a two-spoke target plate that is rotating over two pairs of capacitive sensors, according to some embodiments. In some embodiments, the CD rotary encoder 300 includes a pair of capacitive sensors 302, 304 and a pair of capacitive sensors 306, 308. In some embodiments, the CD rotary encoder 300 includes a central ground pad 350, in that it is positioned in the center of the circular shape of the CD rotary encoder 300. In some embodiments, the CD rotary encoder 300 includes a target plate 320 and an axis (not shown in FIG. 3) for the target plate 320 to rotate about the axis.

In some embodiments, the target plate 320 includes spokes 322, 324, 326, 328. In some embodiments, the doubling of the number of capacitive sensors of the CD rotary encoder 300 as compared to the number of capacitive sensors of the CD rotary encoder 200 allows the CD rotary encoder 300 to double its capacitance, thereby eliminating a step for software accumulation and/or reducing the number of pins (e.g., signal nodes and ground nodes) for connecting to the integrated circuit 100 in FIG. 1.

In some embodiments, the CD rotary encoder 300 may include a source plate 301, where the capacitive sensors 302, 304, 306, 308 and the axis may each be attached (e.g., adhered, affixed, included, embedded) to the source plate 301. In this regard, the capacitive sensors 302, 304, 306, 308 are stationary with respect to the source plate 301. In some embodiments, a source plate 301 may correspond to a side of a three-dimensional joystick housing such that the capacitive sensors 302, 304, 306, 308 and the axis may each be attached to the side of the joystick housing.

In some embodiments, the capacitive sensor 302 and the capacitive sensor 308 are electrically coupled to a signal node 360. In some embodiments, the capacitive sensor 304 and the capacitive sensor 306 are electrically coupled to a signal node 362. In some embodiments, the central ground pad 350 is electrically coupled to a ground node 364. In some embodiments, the signal nodes 360, 362, and the ground node 364 are electrically coupled to corresponding pads of the integrated circuit 100 in FIG. 1.

As shown in FIG. 3, the CD rotary encoder 300 and the target plate 320 may each be circular. In some embodiments, the CD rotatory encoder 300 and/or the target plate 320 may be any shape, such as a rectangle, a square, a triangle, a circle, etc. The capacitive sensors 302, 304 are attached to the source plate 301 in an arrangement where an inner edge of the capacitive sensor 302 (sometimes referred to as, “inner capacitive sensor 302”) is closer to the center of the target plate 320 as compared to an outer edge of the capacitive sensor 302, and an inner edge of the capacitive sensor 304 (sometimes referred to as, “outer capacitive sensor 304”) is closer to the outer edge of the capacitive sensor 302 as compared to an outer edge of the capacitive sensor 304. The capacitive sensors 306, 308 are attached to the source plate 301 in an arrangement where an inner edge of the capacitive sensor 308 (sometimes referred to as, “inner capacitive sensor 308”) is closer to the center of the target plate 320 as compared to an outer edge of the capacitive sensor 308, and an inner edge of the capacitive sensor 306 (sometimes referred to as, “outer capacitive sensor 306”) is closer to the outer edge of the capacitive sensor 308 as compared to an outer edge of the capacitive sensor 306.

In some embodiments, the target plate 320 may be separated from the source plate 301 by a gap. In some embodiments, the spokes 322, 324 may be capacitively coupled to the capacitive sensors 302, 304. In some embodiments, the target plate 320 may be separated from the source plate 301 by a gap. In some embodiments, the spokes 326, 328 may be capacitively coupled to the capacitive sensors 306, 308. In some embodiments, the spokes 322, 324 may be capacitively coupled to capacitive sensors 302, 304 at the same time that the spokes 326, 328 may be capacitively coupled to capacitive sensors 306, 308.

In some embodiments, the target plate 320 may be mechanically coupled to a joystick (not shown in FIG. 2), such that a movement of the joystick may cause the target plate 320 (and its spokes 322, 324, 326, 328) to rotate about the axis. In this instance, the rotation of the target plate 320 about the axis causes a change in the angular position of the spokes 322, 324, 326, 328 with respect to the capacitive sensors, 302, 304, 306, 308.

In some embodiments, a capacitive sensor may be configured to detect a change in a capacitive value, where the change corresponds to an angular position of one or more regions of the target plate 320 to the capacitive sensor. In some embodiments, a capacitive sensor may be configured to detect a change in a capacitive value, where the change corresponds to an angular position of one or more spokes 322, 324, 326, 328 to the capacitive sensor. In some embodiments, a region of the target spoke corresponds to a region of any of the spokes 322, 324, 326, 328.

In some embodiments, the capacitive sensor 302 may be electrically coupled to the capacitive sensor 308. In some embodiments, the capacitive sensor 304 may be electrically coupled to the capacitive sensor 306. In some embodiments, the spoke 322 and the spoke 326 may be separated by 180+/−5 degrees. In some embodiments, the spoke 324 and the spoke 328 may be separated by 180+/−5 degrees.

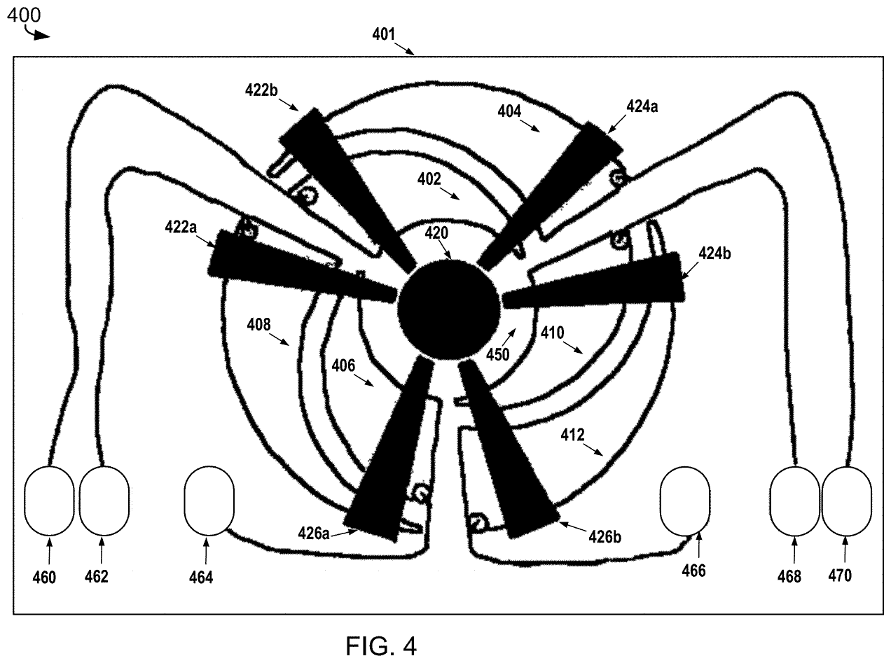

FIG. 4 illustrates a block diagram of an example capacitive differential rotary encoder for capturing angular position of a three-spoke target plate that is rotating over three pairs of capacitive sensors, according to some embodiments. In some embodiments, the CD rotary encoder 400 includes a pair of capacitive sensors 402, 404, a pair of capacitive sensors 406, 408, and a pair of capacitive sensors 410, 412. In some embodiments, the CD rotary encoder 400 includes a central ground pad 450, in that it is positioned in the center of the circular shape of the CD rotary encoder 400. In some embodiments, the CD rotary encoder 400 includes a target plate 420 and an axis (not shown in FIG. 4) for the target plate 420 to rotate about the axis.

In some embodiments, the target plate 420 includes spokes 422a, 422b 424a, 424b, 426b, 426b. In some embodiments, the pair of spokes 422a, 422b may collectively be referred to as a single spoke, the pair of spokes 424a, 424b collectively be referred to as a single spoke, and the pair of spokes 426b, 426b collectively be referred to as a single spoke; such that the target plate 420 may correspond to a three-spoke target plate. In some embodiments, the pair of spokes 422a, 422b, the pair of spokes 424a, 424b, and the pair of spokes 426b, 426b are each separated by 120+/−5 degrees.

In some embodiments, the CD rotary encoder 400 may include a source plate 401, where the capacitive sensors 402, 404, 406, 408, 410, 412 and the axis may each be attached to the source plate 401. In this regard, the capacitive sensors 402, 404, 406, 408, 410, 412 are stationary with respect to the source plate 401. In some embodiments, a source plate 401 may correspond to a side of a three-dimensional joystick housing such that the capacitive sensors 402, 404, 406, 408, 410, 412 and the axis may each be attached to the side of the joystick housing.

In some embodiments, the capacitive sensor 402 is electrically coupled to a signal node 460. In some embodiments, the capacitive sensor 406 is electrically coupled to a signal node 464. In some embodiments the capacitive sensor 410 is coupled to a signal node 468. In some embodiments, the capacitive sensor 404 is electrically coupled to a signal node 470. In some embodiments, the capacitive sensor 412 is electrically coupled to a signal node 466. In some embodiments, the capacitive sensor 408 is electrically coupled to a signal node 462. In some embodiments, the central ground pad 450 is electrically coupled to a ground node 464. In some embodiments, the signal nodes 460, 462, and the ground node 464 are electrically coupled to corresponding pads of the integrated circuit 100 in FIG. 1.

In some embodiments, the CD rotary encoder 400 operates similar to the CD rotary encoder 300, with the exception that the CD rotary encoder 400 includes three pairs of capacitive sensors and three spokes. In some embodiments, the increase in the number of capacitive sensors of the CD rotary encoder 400 as compared to the number of capacitive sensors of the CD rotary encoder 300 allows the CD rotary encoder 400 to further increase its capacitance, thereby eliminating a step for software accumulation and/or reducing the number of pins (e.g., signal nodes and ground nodes) for connecting to the integrated circuit 100 in FIG. 1.

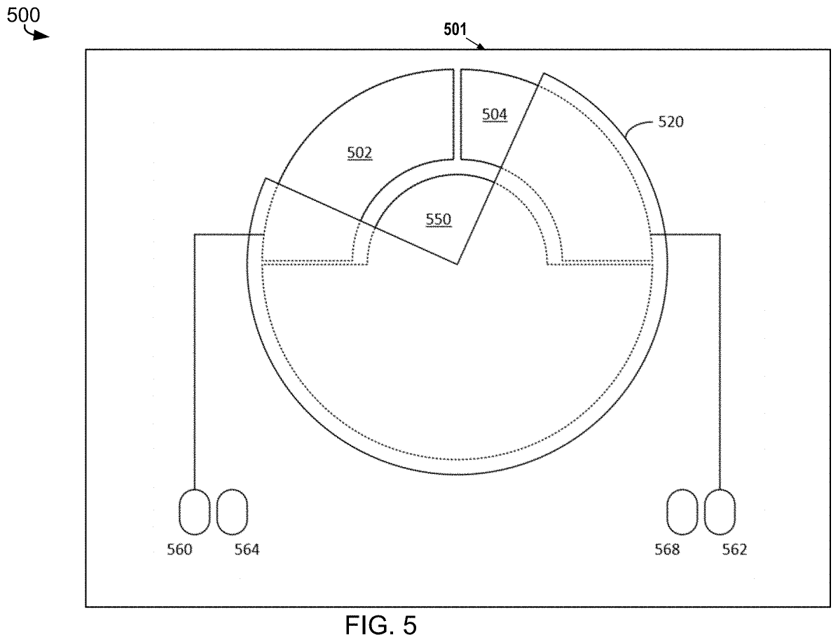

FIG. 5 illustrates a block diagram of an example capacitive differential rotary encoder for capturing angular position of a horseshoe target plate that is rotating over two curved-rectangular capacitive sensors, according to some embodiments. In some embodiments, the CD rotary encoder 500 includes a pair of capacitive sensors 502, 504 that each have a curved-rectangular shape. In some embodiments, the first curved-rectangle sensor and/or the second curved-rectangle sensor includes a curve of 115+/−5 degrees. In some embodiments, the CD rotary encoder 500 includes a central ground pad 550, in that it is positioned in the center of the circular shape of the CD rotary encoder 500.

In some embodiments, the CD rotary encoder 500 includes a target plate 520 and an axis (not shown in FIG. 5) for the target plate 520 to rotate about the axis. In some embodiments, the target plate 520 has a circular shape (sometimes referred to as, “horseshoe shape”) with a missing circular sector. In some embodiments, the horseshoe target plate does not have any spokes. In some embodiments, the circular sector has a central angle of 130+/−5 degrees.

In some embodiments, the CD rotary encoder 500 may include a source plate 501, where the capacitive sensors 502, 504 and the axis may each be attached to the source plate 501. In this regard, the capacitive sensors 502, 504 are stationary with respect to the source plate 501. In some embodiments, a source plate 501 may correspond to a side of a three-dimensional joystick housing such that the capacitive sensors 502, 504 and the axis may each be attached to the side of the joystick housing.

In some embodiments, the capacitive sensor 502 is electrically coupled to a signal node 560. In some embodiments, the capacitive sensor 504 is electrically coupled to a signal node 562. In some embodiments, the central ground pad 550 is electrically coupled to ground nodes 564, 566. In some embodiments, the signal nodes 560, 562, and the ground nodes 564, 566 are electrically coupled to corresponding pads of the integrated circuit 100 in FIG. 1.

In some embodiments, the curved-rectangular shape of the capacitive sensors 502, 504 and/or the horseshoe shape (e.g., a pac-man shape) of the target plate 520 of the CD rotary encoder 500 results in the largest coupling to ground and the largest change in capacitance per change in position, as compared to the CD rotary encoders 200, 300, 400. In some embodiments, the CD rotary encoder 500 allows for a reduction in the number of pins (e.g., signal nodes and ground nodes) for connecting to the integrated circuit 100 in FIG. 1.

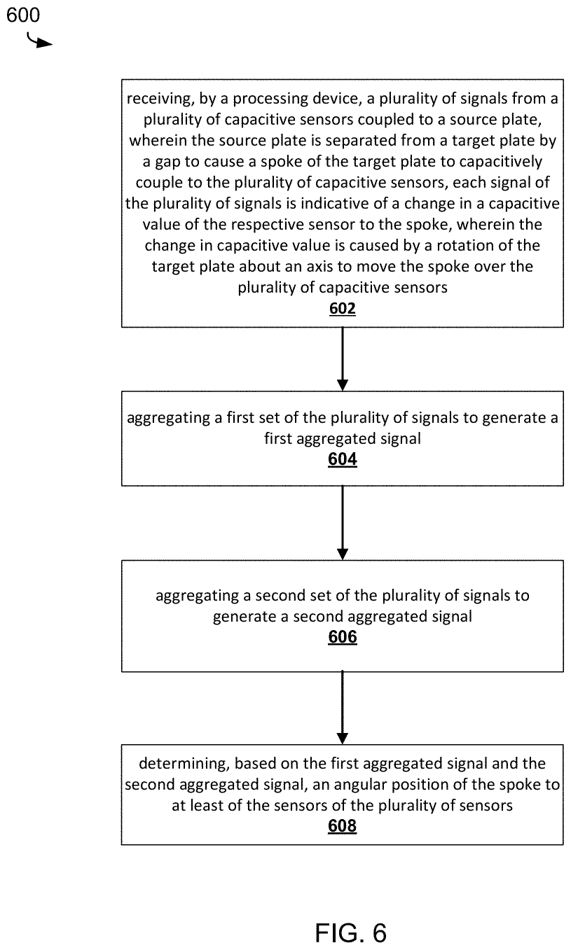

FIG. 6 is a flow diagram of a method for capturing angular position of a target rotating over one or more capacitive sensors, according to some embodiments. Although the operations are depicted in FIG. 6 as integral operations in a particular order for purposes of illustration, in other implementations, one or more operations, or portions thereof, are performed in a different order, or overlapping in time, in series or parallel, or are omitted, or one or more additional operations are added, or the method is changed in some combination of ways. In some embodiments, the method 600 may be performed by processing logic that comprises hardware (e.g., circuitry, dedicated logic, programmable logic, microcode, etc.), firmware, or a combination thereof. In some embodiments, some or all operations of method 600 may be performed by processing logic (integrated circuit 100 in FIG. 1).

The method of 600, in some embodiments, may include the operation 602 of receiving, by a processing device, a plurality of signals from a plurality of capacitive sensors attached to a source plate. In some embodiments, the source plate is separated from a target plate by a gap to cause a spoke of the target plate to capacitively couple to the plurality of capacitive sensors. In some embodiments, each signal of the plurality of signals includes information that is indicative of a change in a capacitive value of the respective sensor to the spoke, wherein the change in capacitive value is caused by a rotation of the target plate about an axis to move the spoke over the plurality of capacitive sensors.

The method of 600, in some embodiments, may include the operation 604 of aggregating a first set of the plurality of signals to generate a first aggregated signal. For example, the integrated circuit 100 in FIG. 1 may average the first set of the plurality of signals to generate a first averaged signal.

The method of 600, in some embodiments, may include the operation 606 of aggregating a second set of the plurality of signals to generate a second aggregated signal. For example, the integrated circuit 100 in FIG. 1 may average the second set of the plurality of signals to generate a second averaged signal.

The method of 600, in some embodiments, may include the operation 608 of determining (e.g., calculating, estimating, measuring), based on the first aggregated signal and the second aggregated signal, an angular position of the spoke to at least of the sensors of the plurality of sensors.

In the above description, some portions of the detailed description are presented in terms of algorithms and symbolic representations of operations on analog signals and/or digital signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the disclosure. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “communicating,” “modifying,” “measuring,” “determining,” “detecting,” “sending,” “comparing,” “maintaining,” “switching,” “controlling,” “generating,” or the like, refer to the actions and processes of an integrated circuit (IC) controller , or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus (e.g., such as an AC-DC converter, and/or an ESD protection system/circuit) for performing the operations herein. This apparatus may be specially constructed for the required purposes, or it may comprise firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A rotary encoder, comprising:
a source plate;
a ground pad coupled to the source plate;
a pair of capacitive sensors coupled to the source plate; and
a target plate separated from the source plate by a gap, the target plate comprising a spoke and a flange, the spoke is capacitively coupled to the pair of capacitive sensors and the flange is capacitively coupled to the ground pad;
wherein each capacitive sensor of the pair of capacitive sensors is configured to detect a change in a capacitive value corresponding to an angular position of the spoke to the capacitive sensor, and
wherein the target plate is mechanically coupled to a joystick, a movement of the joystick causes a rotation of the target plate about an axis to change the angular position of the spoke to the pair of capacitive sensors.

2. The rotary encoder of claim 1, wherein
a first capacitive sensor of the pair of capacitive sensors generates, responsive to detecting the change in the capacitive value of the first capacitive sensor, a first signal that is indicative of the change in the capacitive value of the first capacitive sensor, and
a second capacitive sensor of the pair of capacitive sensors generates, responsive to detecting the change in the capacitive value of the second capacitive sensor, a second signal that is indicative of the change in the capacitive value of the second capacitive sensor.

3. The rotary encoder of claim 2, wherein a width of the spoke is directly related to a power level of the first signal and a power level of the second signal.

4. The rotary encoder of claim 1, wherein a width of the spoke is inversely related to an angular resolution of the first capacitive sensor and an angular resolution of the second capacitive sensor.

5. The rotary encoder of claim 3, wherein each capacitive sensor of the pair of capacitive sensors is fin-shaped with an inner radius corresponding to a radius of the target plate.

6. The rotary encoder of claim 5, wherein the rotation of the target plate about the axis causes the spoke to move in an arc over the pair of capacitive sensors.

7. The rotary encoder of claim 5, the power level of the first signal is directly related to a size of an area of the first capacitive sensor that is overlapped by the spoke, and the power level of the second signal is directly related to a size of an area of the second capacitive sensor that is overlapped by the spoke.

8. The rotary encoder of claim 5, wherein the first capacitive sensor and the second capacitive sensor are coupled to the source plate in a mirror orientation that causes the first capacitive sensor and the second capacitive sensor generate complementary signals responsive to the rotation of the target plate about the axis.

9. The rotary encoder of claim 1, wherein a width of the spoke is equal to or less than a width of the pair of capacitive sensors.

10. The rotary encoder of claim 1, wherein the pair of capacitive sensors have an arc length of 120 degrees+/−5 degrees.

11. A rotary encoder, comprising:
a source plate;
a ground pad coupled to a center of the source plate;
a plurality of pairs of capacitive sensors that are coupled to the source plate; and
a target plate separated from the source plate by a gap;
wherein each capacitive sensor of the plurality of pairs of capacitive sensors is configured to detect a change in a capacitive value corresponding to an angular position of one or more regions of the target plate to the capacitive sensor, and
wherein the target plate is mechanically coupled to a joystick, a movement of the joystick causes a rotation of the target plate about an axis to change the angular position of the one or more regions of the target plate to the plurality of pairs of capacitive sensors.

12. The rotary encoder of claim 11, wherein the target plate comprises a first spoke and a second spoke, wherein each capacitive sensor of the plurality of pairs of capacitive sensors detects the change in the capacitive value corresponding to at least one of an angular position of a first region of the first spoke to the capacitive sensor or an angular position of a second region of the second spoke to the capacitive sensor, wherein the movement of the joystick causes the rotation of the target plate about the axis to change an angular position of the first region of the first spoke to the capacitive sensor and the angular position of the second region of the second spoke to the capacitive sensor.

13. The rotary encoder of claim 11, wherein each pair of the capacitive sensors comprises an inner capacitive sensor and an outer capacitive sensor, the inner capacitive sensors of the plurality of pairs of capacitive sensors are electrically coupled together and the outer capacitive sensors of the plurality of pairs of capacitive sensors are electrically coupled together.

14. The rotary encoder of claim 11, wherein the plurality of pairs of capacitive sensors corresponds to two pairs of capacitive sensors, and the first spoke and the second spoke are separated by 180 degrees+/−5 degrees.

15. The rotary encoder of claim 11, wherein
the plurality of pairs of capacitive sensors corresponds to three pairs of capacitive sensors,
the target plate further comprises a third spoke, and
the first spoke, the second spoke, and the third spoke are each separated by 120 degrees+/−5 degrees.

16. The rotary encoder of claim 11, wherein the target plate is a circle shape having a missing circular sector.

17. The rotary encoder of claim 16, wherein the plurality of pairs of capacitive sensors comprises a first curved-rectangle sensor and a second curved-rectangle sensor.

18. The rotary encoder of claim 17, wherein each of the first curved-rectangle sensor and the second curved-rectangle sensor includes a curve of 115 degrees+/−5 degrees.

19. The rotary encoder of claim 18, wherein the circular sector has a central angle of 130 degrees+/−5 degrees.

20. A method, comprising:
receiving, by a processing device, a plurality of signals from a plurality of capacitive sensors coupled to a source plate, wherein the source plate is separated from a target plate by a gap to cause a spoke of the target plate to capacitively couple to the plurality of capacitive sensors, each signal of the plurality of signals is indicative of a change in a capacitive value of the respective sensor to the spoke, wherein the change in capacitive value is caused by a rotation of the target plate about an axis to move the spoke over the plurality of capacitive sensors;
aggregating a first set of the plurality of signals to generate a first aggregated signal;
aggregating a second set of the plurality of signals to generate a second aggregated signal; and
determining, based on the first aggregated signal and the second aggregated signal, an angular position of the spoke to at least of the sensors of the plurality of sensors.
